(19) United States
(12) Patent Application Publication
(10) Pub. No.: US 2019/0056243 A1
(43) Pub. Date: Feb. 21, 2019

(54) Electromagnetic tracking system using rotating permanent magnets for field generation

(71) Applicant: Boston Scientific Scimed Inc., Maple Grove, MN (US)

(72) Inventors: Daniel J. Foster, Lino Lakes, MN (US); Roger N. Hastings, Maple Grove, MN (US); David R. Wulfman, Minneapolis, MN (US); Michael A. Felling, Stillwater, MN (US); Matthew Hein, Eden Prairie, MN (US); Connor D. Rousemiller, Lakeville, MN (US)

(21) Appl. No.: 15/998,692

(22) Filed: Aug. 16, 2018

Related U.S. Application Data
(60) Provisional application No. 62/546,525, filed on Aug. 16, 2017.

(51) Int. Cl. G01D 5/20

(52) U.S. Cl. CPC G01D 5/2046

(57) ABSTRACT

A system includes a magnetic field transmitter assembly. The magnetic field transmitter assembly includes an enclosure, a magnet positioned within the enclosure, and a plurality of coils wrapped around the enclosure. The plurality of coils are configured to be energized to rotate the magnet In certain embodiments, the plurality of coils include a first set of windings and a second set of windings where the first set of windings is configured to generate a first magnetic field in a first direction and where the second set of windings is configured to generate a second magnetic field in a second direction different than the first direction.

### CROSS-REFERENCE TO RELATED APPLICATION

This application claims priority to Provisional Application No. 62/546,525, filed Aug. 16, 2017, which is herein incorporated by reference in its entirety.

### TECHNICAL FIELD

The present disclosure relates to systems, methods, and devices for tracking items. More specifically, the disclosure relates to systems, methods, and devices for electro-magnetically tracking medical devices used in medical procedures.

### BACKGROUND

A variety of systems, methods, and devices can be used to track medical devices. Tracking systems can use generated magnetic fields that are sensed by at least one tracking sensor in the tracked medical device. The generated magnetic fields provide a fixed frame of reference, and the tracking sensor senses the magnetic fields to determine the location and orientation of the sensor in relation to the fixed frame of reference.

### SUMMARY

In Example 1, a system includes a magnetic field transmitter assembly. The magnetic field transmitter assembly includes an enclosure, a magnet positioned within the enclosure, and a plurality of coils wrapped around the enclosure. The plurality of coils are configured to be energized to rotate the magnet.

In Example 2, the system of Example 1, wherein the magnet comprises either NeFeB or SmCo.

In Example 3, the system of any of Examples 1-2, wherein the magnet includes a coating.

In Example 4, the system of any of Examples 1-3, wherein the magnet has a single preferred magnetic orientation.

In Example 5, the system of any of Examples 1-4, wherein the magnet is either a sphere or a cylinder.

In Example 6, the system of any of Examples 1-5, wherein the magnet has a diameter of 0.1 inch-1 inch.

In Example 7, the system of any of Examples 1-8, wherein the magnet is a dipole magnet.

In Example 8, the system of any of Examples 1-7, wherein the magnetic field transmitter assembly includes a subassembly positioned within the enclosure and that forms an internal volume in which the magnet is positioned.

In Example 9, the system of Example 8, wherein the subassembly includes a clam-shell assembly that forms the internal volume.

In Example 10, the system of any of Examples 8-9, wherein the internal volume includes a lubricant.

In Example 11, the system of any of Examples 1-10, wherein the subassembly comprises a non-magnetic material.

In Example 12, the system of any of Examples 1-11, wherein the magnetic field transmitter assembly includes a magnetic sensor coupled to the enclosure, and wherein the magnetic sensor is configured to detect a rotating magnetic field generated by the magnet.

In Example 13, the system of any of Examples 1-12, wherein the plurality of coils includes a first set of windings, a second set of windings, and a third set of windings wrapped orthogonally to each other.

In Example 14, the system of any of Examples 1-13, wherein the plurality of coils includes either two or three sets of Helmholtz windings.

In Example 15, the system of any of Examples 1-14, further comprising a magnetic field controller configured to control current to the plurality of coils to produce a substantially constant torque to the magnet.

In Example 16, a system includes a magnetic field transmitter assembly. The magnetic field transmitter assembly includes an enclosure, a magnet positioned within the enclosure, and a plurality of coils wrapped around the enclosure. The plurality of coils include a first set of windings and a second set of windings. The first set of windings is configured to generate a first magnetic field in a first direction. The second set of windings is configured to generate a second magnetic field in a second direction different than the first direction. The plurality of coils are configured to be driven to rotate the magnet.

In Example 17, the system of Example 16, wherein the magnet comprises either NeFeB or SmCo.

In Example 18, the system of any of Examples 16-17, wherein the magnet includes a coating.

In Example 19, the system of any of Examples 16-18, wherein the magnet has a single preferred magnetic orientation.

In Example 20, the system of any of Examples 16-19, wherein the magnet is either a sphere or a cylinder.

In Example 21, the system of any of Examples 16-20, wherein the magnet has a diameter of 0.1 inch-1 inch.

In Example 22, the system of any of Examples 16-21, wherein the magnet is a dipole magnet.

In Example 23, the system of any of Examples 16-22, wherein the magnetic field transmitter assembly includes a subassembly positioned within the enclosure and that forms an internal volume in which the magnet is positioned.

In Example 24, the system of Example 23, wherein the subassembly includes a clam-shell assembly that forms the internal volume.

In Example 25, the system of Example 23, wherein the internal volume includes a lubricant.

In Example 26, the system of any of Examples 23-25, wherein the subassembly comprises a non-magnetic material.

In Example 27, the system of any of Examples 16-26, wherein the plurality of coils further includes a third set of windings wrapped orthogonally to the first set of windings and the second set of windings.

In Example 28, the system of any of Examples 16-27, wherein the plurality of coils includes either two or three sets of Helmholtz-paired windings.

In Example 29, the system of any of Examples 16-28, further comprising circuitry configured to control current to the plurality of coils to produce a substantially constant torque to the magnet.

In Example 30, the system of Example 29, wherein the circuitry includes an offset compensator, an adjustable gain unit, and a power amplifier.

In Example 31, a method uses a magnetic field transmitter assembly to generate a rotating magnetic field. The magnetic field transmitter assembly includes an enclosure, a magnet positioned within the enclosure, and a plurality of coils positioned around the enclosure. The method further includes energizing the plurality of coils to generate a plurality of magnetic fields that move the magnet such that the magnetic field transmitter assembly generates a rotating magnetic field.

In Example 32, the method of Example 31, wherein the magnet is moved to rotate around a single axis.

In Example 33, the method of Example 31, wherein the magnet is moved to rotate such that a magnetization vector of the magnet traverses all directions.

In Example 34, the method of any of Examples 31-33, further comprising tracking a position and orientation of a medical device by sensing the rotating magnetic field with a magnetic sensor positioned in the medical device.

In Example 35, the method of any of Examples 31-34, wherein the magnet is rotated at 5000 revolutions per minute (RPMs) to 200,000 RPMs.

In Example 36, the systems or method of any of Examples 1-35, wherein the magnet is coated with a metal or plastic.

In Example 37, the systems or method of any of Examples 1-35, wherein the magnet is coated with one of a fluoropolymer, wax, oil, hydrocarbon, silicone, paylene, water, plasma coating, graphite, acetal, PEEK, HDPE, ceramic, oxide, and nitride.

In Example 38, the systems or method of any of Examples 1-37, further comprising a signal processor configured to determine a location of a medical device based on phase and/or amplitude of the generated rotating magnetic fields.

In Example 39, the systems or method of any of Examples 1-38, further comprising a medical device including a receiver configured to sense the generated rotating magnetic fields.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a schematic of a tracking system, in accordance with certain embodiments of the present disclosure.

FIG. 2 shows a block representation of a computing device, in accordance with certain embodiments of the present disclosure.

FIG. 3A shows a schematic of a side view of a magnetic field transmitter assembly, in accordance with certain embodiments of the present disclosure.

FIG. 3B shows a perspective view of the magnetic field transmitter assembly of FIG. 3A.

FIG. 4 shows a schematic, exploded view of a subassembly of a magnetic field transmitter assembly, in accordance with certain embodiments of the present disclosure.

FIG. 5 shows a block representation of a magnetic field controller, magnetic field sensors, and coils, in accordance with certain embodiments of the present disclosure.

FIGS. 6A-C show schematic representations of a magnet and coils, in accordance with certain embodiments of the present disclosure.

FIGS. 7A and 7B show schematics of a magnetic field transmitter assembly, in accordance with certain embodiments of the present disclosure.

FIGS. 8A and 8B show representations of magnetic field controller circuitry, in accordance with certain embodiments of the present disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

During medical procedures, medical devices such as probes (e.g., catheters) are inserted into a patient. To track the location and orientation of a probe within the patient, probes can be provisioned with magnetic field sensors that detect various magnetic fields generated by transmitters near the patient. For example, transmitters can generate what may be described as rotating magnetic fields. Rotating magnetic field-based tracking can utilize phase—rather than or in addition to amplitude—of the detected fields to determine location and orientation of the probe. Phase-based tracking has certain advantages such as being less sensitive to sensor noise as compared to noise sensitivity of amplitude-based tracking—although phase-based tracking can be used along with amplitude-based tracking. Certain embodiments of the present disclosure are accordingly directed to systems, methods, and devices including magnetic field transmitter assemblies that generate rotating magnetic fields.

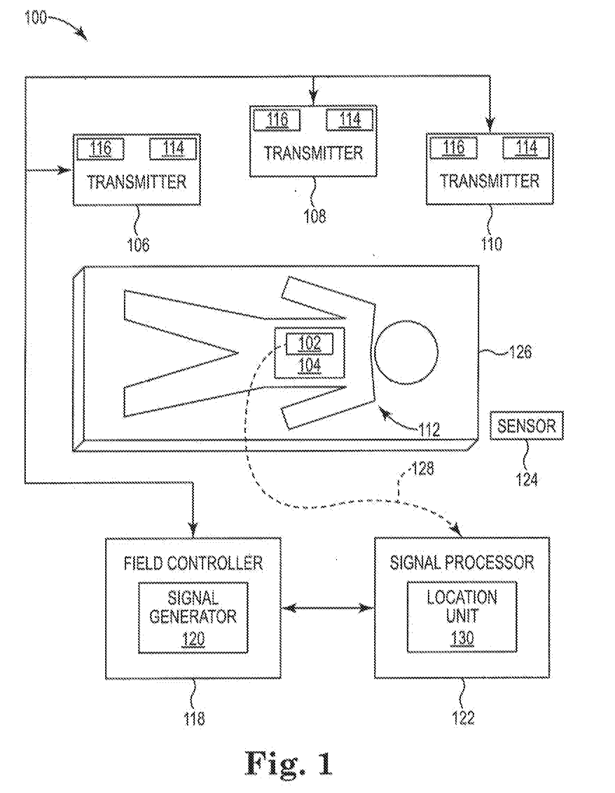

FIG. 1 is a schematic block diagram depicting a tracking system 100 that is configured to determine location information corresponding to the medical device 104 based on information collected using a receiver (e.g., sensor) 102 associated with a medical device 104. The information collected by the receiver 102 includes a received field signal corresponding to an electromagnetic field defined by a set of electromagnetic signals transmitted by one or more magnetic field transmitter assemblies 106, 108, and 110 (e.g., rotating magnetic field transmitter assemblies). Although only three magnetic field transmitter assemblies are shown, the system 100 can include fewer or more magnetic field transmitter assemblies. For example, to provide six-degree-of-freedom tracking, the tracking system 100 should include at least one magnetic field transmitter assembly when the receiver 102 includes a three-axis magnetic sensor. Additional magnetic field transmitter assemblies can be used to extend the range and accuracy of tracking. When the receiver 102 includes a dual-axis magnetic sensor, the tracking system 100 should include at least two magnetic field transmitter assemblies. In embodiments with multiple magnetic field transmitter assemblies, the magnetic field transmitter assemblies can be coupled to a common housing or placed individually. At least one magnetic field transmitter assembly can be placed under a patient's bed, under the patient but above the patient's bed, and/or placed above the patient (e.g., placed directly on top of the patient or suspended above the patient). Further, in embodiments with multiple magnetic field transmitter assemblies, each magnetic field transmitter assembly can be driven at different frequencies.

According to embodiments, one or more magnetic field transmitter assemblies 106, 108, and 110, are configured to transmit (e.g., radiate) electromagnetic signals, which produce a magnetic field (e.g., rotating magnetic field) within which a subject 112 is disposed. As discussed in more detail below, each magnetic field transmitter assembly may include a magnet 114 that is rotated and that generates a rotating magnetic field. Each magnetic field transmitter assembly may also include coils 116 that, when energized, create torque that rotates the magnet.

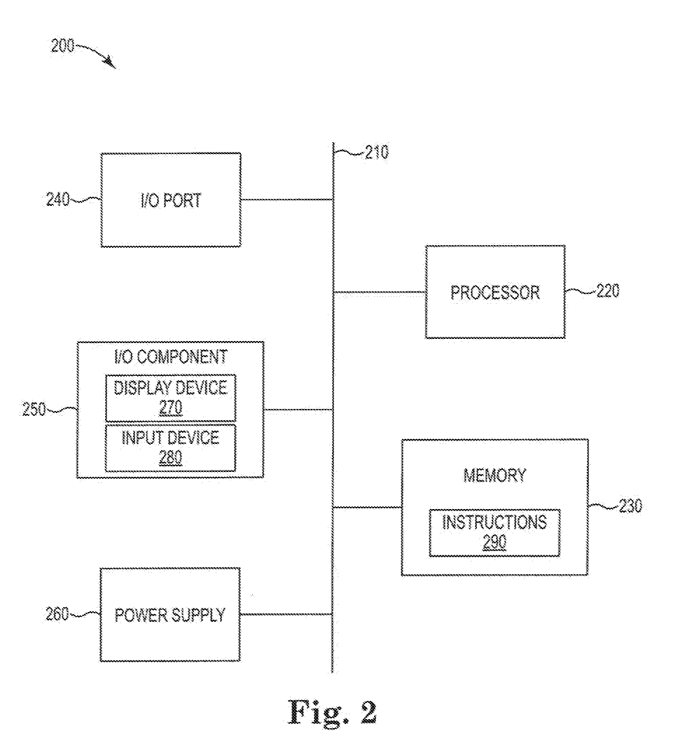

The system 100 includes a magnetic field controller 118 configured to manage operation of the magnetic field transmitter assemblies 106, 108, and 110. As shown in FIG. 1, the magnetic field controller 118 includes a signal generator 120 configured to provide driving current to each of the magnetic field transmitter assemblies 106, 108, and 110, causing each magnetic field transmitter assembly to transmit an electromagnetic signal, which causes the magnet to rotate. In certain embodiments, the signal generator 120 is configured to provide sinusoidal driving currents to the magnetic field transmitter assemblies 106, 108, and 110. The magnetic field controller 118 can be implemented using firmware, integrated circuits, and/or software modules that interact with each other or are combined together. For example, the magnetic field controller 118 may include computer-readable instructions/code for execution by a processor (see FIG. 2). Such instructions may be stored on a non-transitory computer-readable medium (see FIG. 2) and transferred to the processor for execution. In some embodiments, the magnetic field controller 118 can be implemented in one or more application-specific integrated circuits and/or other forms of circuitry suitable for controlling and processing magnetic tracking signals and information.

The receiver 102 (e.g., magnetic field sensor) (which may include one or more receivers/sensors) may be configured to produce an electrical response to the rotating magnetic field(s) generated by the magnetic field transmitter assemblies 106, 108, and 110. For example, the receiver 102 may include a magnetic field sensor such as inductive sensing coils and/or various sensing elements such as magneto-resistive (MR) sensing elements (e.g., anisotropic magneto-resistive (AMR) sensing elements, giant magneto-resistive (GMR) sensing elements, tunneling magneto-resistive (TMR) sensing elements, Hall effect sensing elements, colossal magneto-resistive (CMR) sensing elements, extraordinary magneto-resistive (EMR) sensing elements, spin Hall sensing elements, and the like), giant magneto-impedance (GMI) sensing elements, and/or flux-gate sensing elements.

The sensed rotating magnetic field may include multiple rotating magnetic field signals, each of which may be processed to extract field components corresponding to one or more magnetic field transmitter assemblies. The sensed rotating magnetic field signal is communicated to a signal processor 122, which is configured to analyze the sensed rotating magnetic field signal to determine location information corresponding to the receiver 102 (and, thus, the medical device 104). Location information may include any type of information associated with a location and/or position of a medical device 104 such as, for example, location, relative location (e.g., location relative to another device and/or location), position, orientation, velocity, acceleration, and/or the like. As mentioned above, rotating magnetic field-based tracking can utilize phase (e.g., differences in phase) of the sensed magnetic field signal to determine location and orientation of the probe.

The tracking system 100 can also include at least one sensor 124 that is configured and arranged to sense the magnetic fields generated by the magnetic field transmitter assemblies, 106-110. The sensor 124 can be a magnetic sensor (e.g., dual-axis magnetic sensor, tri-axis magnetic sensor) and be positioned at a known reference point in proximity to the magnetic field transmitter assemblies, 106-110, to act as a reference sensor. For example, one or more sensors 124 can be coupled to a subject's bed 126, an arm of an x-ray machine, or at other points a known distance from the magnetic field transmitter assemblies, 106-110. In some embodiments, the at least one sensor 124 is mounted to one of the magnetic field transmitter assemblies, 106-110.

The medical device 104 may include, for example, a catheter (e.g., a mapping catheter, an ablation catheter, a diagnostic catheter, an introducer), an endoscopic probe or cannula, an implantable medical device (e.g., a control device, a monitoring device, a pacemaker, an implantable cardioverter defibrillator (ICD), a cardiac resynchronization therapy (CRT) device, a CRT-D device), guidewire, biopsy needle, ultrasound device, reference patch, robot and/or the like. For example, in embodiments, the medical device 104 may include a mapping catheter associated with an anatomical mapping system. The medical device 104 may include any other type of device configured to be at least temporarily disposed within a subject 112. The subject 112 may be a human, a dog, a pig, and/or any other animal having physiological parameters that can be recorded. For example, in embodiments, the subject 112 may be a human patient.

As shown in FIG. 1, the medical device 104 may be configured to be disposed within the body of the subject 112, and may be configured to be communicatively coupled to the signal processor 122 via a communication link 128 (shown in phantom). In embodiments, the communication link 128 may be, or include, a wired communication link (e.g., a serial communication), a wireless communication link such as, for example, a short-range radio link, such as Bluetooth, IEEE 802.11, a proprietary wireless protocol, and/or the like. The term “communication link” may refer to an ability to communicate some type of information in at least one direction between at least two devices, and should not be understood to be limited to a direct, persistent, or otherwise limited communication channel. That is, in some embodiments, the communication link 128 may be a persistent communication link, an intermittent communication link, an ad-hoc communication link, and/or the like. The communication link 128 may refer to direct communications between the medical device 104 and the signal processor 122, and/or indirect communications that travel between the medical device 104 and the signal processor 122 via at least one other device (e.g., a repeater, router, hub, and/or the like). The communication link 128 may facilitate uni-directional and/or bi-directional communication between the medical device 104 and the signal processor 122. Data and/or control signals may be transmitted between the medical device 104 and the signal processor 122 to coordinate the functions of the medical device 104 and/or the signal processor 122.

The signal processor 122 further includes a location unit 130 configured to determine, based on the sensed field signal (e.g., the phase, amplitude, differences in phase and/or amplitude of the sensed field signal), location information corresponding to the medical device 104. The location unit 130 may be configured to determine location information according to any location-determination technique that uses magnetic navigation. According to various embodiments of the disclosed subject matter, any number of the components depicted in FIG. 1 (e.g., the field controller 118, the signal generator 120, the signal processor 122) may be implemented on one or more computing devices, either as a single unit or a combination of multiple devices, such as a computing device 200 shown in FIG. 2. The system 100 can include a display for visualizing the position and/or orientation of the medical device 104 in the subject 112.

FIG. 2 is a schematic block diagram depicting an illustrative computing device 200, in accordance with embodiments of the disclosure. The computing device 200 may include any type of computing device suitable for implementing aspects of embodiments of the disclosed subject matter. Examples of computing devices include specialized computing devices or general-purpose computing devices such “workstations,” “servers,” “laptops,” “desktops,” “tablet computers,” “hand-held devices,” “general-purpose graphics processing units (GPGPUs),” and the like, all of which are contemplated within the scope of FIGS. 1 and 2, with reference to various components of the tracking system 100 and/or computing device 200.

In embodiments, the computing device 200 includes a bus 210 that, directly and/or indirectly, couples the following devices: a processor 220, a memory 230, an input/output (I/O) port 240, an I/O component 250, and a power supply 260. Any number of additional components, different components, and/or combinations of components may also be included in the computing device 200. The I/O component 250 may include a presentation component configured to present information to a user such as, for example, a display device, a speaker, a printing device, and/or the like, and/or an input component such as, for example, a microphone, a joystick, a satellite dish, a scanner, a printer, a wireless device, a keyboard, a pen, a voice input device, a touch input device, a touch-screen device, an interactive display device, a mouse, and/or the like.

The bus 210 represents what may be one or more busses (such as, for example, an address bus, data bus, or combination thereof). Similarly, in embodiments, the computing device 200 may include a number of processors 220, a number of memory components 230, a number of I/O ports 240, a number of I/O components 250, and/or a number of power supplies 260. Additionally any number of these components, or combinations thereof, may be distributed and/or duplicated across a number of computing devices. As an example only, the processor 220 may include the signal processor 122, but other suitable configurations are also contemplated to suit different applications.

In embodiments, the memory 230 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In embodiments, the memory 230 stores computer-executable instructions 290 for causing the processor 220 to implement aspects of embodiments of system components discussed herein and/or to perform aspects of embodiments of methods and procedures discussed herein.

The computer-executable instructions 290 may include, for example, computer code, machine-useable instructions, and the like such as, for example, program components capable of being executed by one or more processors 220 associated with the computing device 200. Program components may be programmed using any number of different programming environments, including various languages, development kits, frameworks, and/or the like. Some or all of the functionality contemplated herein may also, or alternatively, be implemented in hardware and/or firmware.

The illustrative computing device 200 shown in FIG. 2 is not intended to suggest any limitation as to the scope of use or functionality of embodiments of the present disclosure. Neither should the illustrative computing device 200 be interpreted as having any dependency or requirement related to any single component or combination of components illustrated therein. Additionally, various components depicted in FIG. 2 may be, in embodiments, integrated with various ones of the other components depicted therein (and/or components not illustrated), all of which are considered to be within the ambit of the present disclosure.

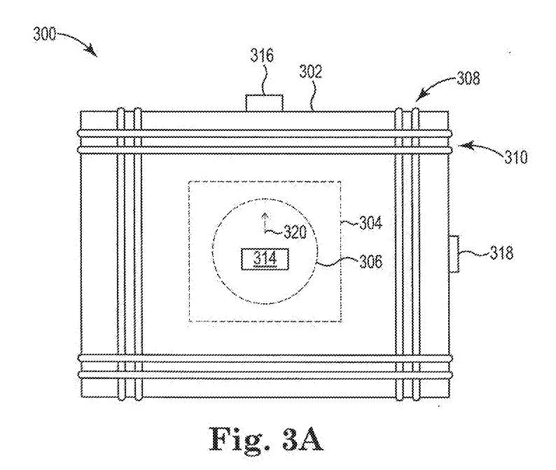

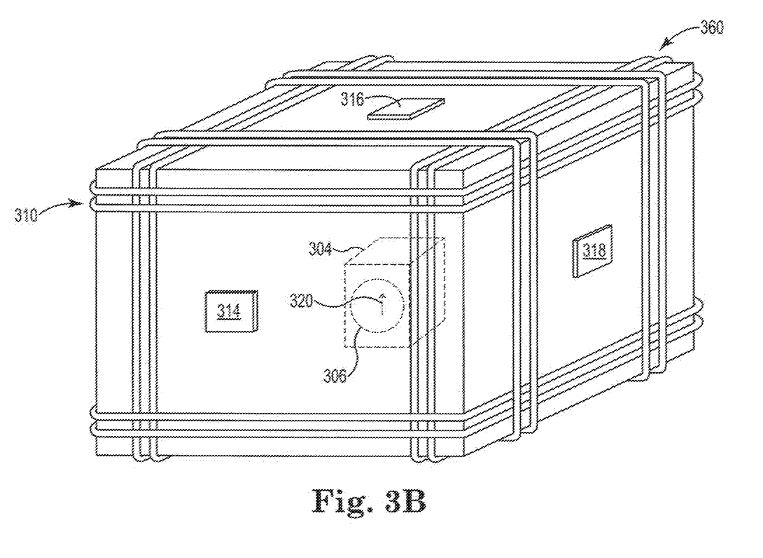

FIGS. 3A and 3B show schematics of a magnetic field transmitter assembly 300 including an enclosure 302, a subassembly 304 (in dotted lines), a magnet 306 (in dotted lines), a first set of coils 308, a second set of coils 310, a third set of coils 312 (shown in FIG. 3B), a first magnetic field sensor 314, a second magnetic field sensor 316, and a third magnetic field sensor 318. Each set of coils can be comprised of a single wire with multiple coil turns around the enclosure 302. The coils can be comprised of conductive materials such as copper.

The first set of coils 308, the second set of coils 310, and the third set of coils 312 are wrapped around the enclosure 302, which houses the subassembly 304 and the magnet 306. Although the enclosure 302 is shown as being cube shaped in FIGS. 3A and 3B, the enclosure 302 can be other shapes (e.g., cubold, sphere, ellipsoid, cylindrical). For simplicity, only a few coil turns are shown as being included in the first set of coils 308, the second set of coils 310, and the third set of coils 312, but each set of coils can include many coils turns. In some embodiments, the sets of coils are wrapped such that the coils substantially cover the enclosure 302. In some embodiments, the sets of coils are wrapped orthogonally with respect to each other. In some embodiments, each set of coils is wrapped in a Helmholtz coil arrangement, which can be referred to as a 3-axis Helmholtz arrangement. For example, as shown in FIGS. 3A and 3B, each set of coils includes subsets of coil windings at ends (e.g., near vertices) of the enclosure 302 that are separated by an area without coil windings. Helmholtz coils may provide a more uniform magnetic field within a volume of the enclosure 302 compared to a magnetic field generated by sets of a single, continuous coils covering faces of the enclosure 302.

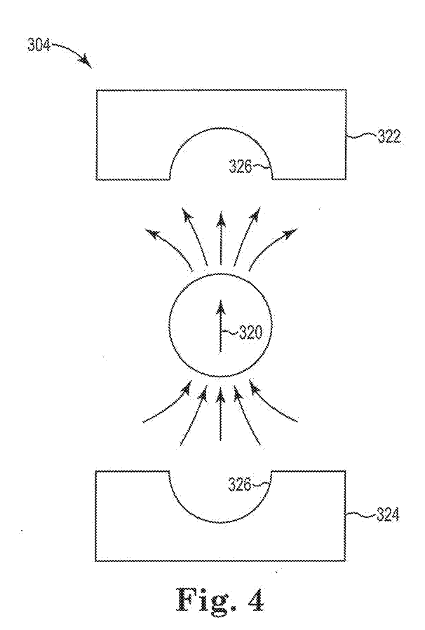

The magnet 306 can comprise various magnetic materials such as Nd, Fe, Co, Sm, and the like. For example, the magnet 306 can comprise permanent magnetic materials such as NdFeB, SmCo, and the like. In some embodiments, the magnet 306 includes a coating that is coated around the permanent magnetic materials and that has a low coefficient of friction and/or high resistance to wear (e.g., to prevent corrosion). For example, the coating can include metal plating (e.g., Ni) surrounding the permanent magnetic materials. In other examples, the coating includes fluoropolymers (including ceramic reinforced fluoropolymers), waxes, oils/hydrocarbons, silicones, paylene, water, plasma coatings, graphite, acetal, PEEK, HDPE, ceramics, oxides/nitrides and the like. The magnet 306 can be a dipole, have a preferred magnetic orientation (represented by arrow 320 in FIGS. 3A, 3B, and 4), and have a uniform magnetization throughout the permanent magnetic material within the magnet 306. FIG. 4 shows an example magnetic field created by a dipole magnet with a preferred magnetic orientation. In some embodiments, the magnet 306 is sphere shaped and has a diameter of 0.1″ to 2″. In some embodiments, the magnet 306 has a diameter of 0.1″ to 1″. For example, the magnet 306 can have a diameter of 0.625″ and comprise grade N42, N48, or N52 Nd material. In another embodiment the spherical magnet has a diameter of 0.5″.

The magnet 306 can be positioned in the subassembly 304, which is shown in an exploded view in FIG. 4. The subassembly 304 can form a clam-shell-like enclosure around the magnet 306. For example, the subassembly 304 can include a first enclosure portion 322 and a second enclosure portion 324 that can be assembled to form an internal volume where the magnet 306 is positioned. The subassembly 304 and the enclosure 302 can comprise non-magnetic materials with low coefficients of friction (e.g., polytetrafluoroethylenes, ceramics) with respect to the coating on the magnet. A lubricant (e.g., fluoropolymers (including ceramic reinforced fluoropolymers), waxes, oils/hydrocarbons, silicones, paylene, water, plasma coatings, graphite, acetal, PEEK, HDPE, ceramics, oxides/nitrides and the like) can be applied to internal surfaces 326 of the subassembly 304 to reduce friction between the internal surfaces 326 and the magnet 306.

During operation, the magnetic field transmitter assembly 300 may be configured to generate a rotating magnetic field. The rotating magnetic field is generated by rotating the magnet 306. In some embodiments, the magnet 306 is rotated at 5000 revolutions per minute (RPMs) to 200,000 RPMs. In some embodiments, the magnet 306 is rotated at 40,000 RPMs to 70,000 RPMs. In some embodiments, the magnet 306 is rotated at 48,000 RPMs to 60,000 RPMs. The magnet 306 is rotated by applying and controlling current applied to the coils (i.e., first set of coils 308, the second set of coils 310, and the third set of coils 312) surrounding the enclosure 302. The applied current generates a magnetic field that, when controlled, causes the magnet 306 to rotate via a controlled torque. Strong permanent magnets (e.g., magnets with high remanence) require relatively weak magnetic fields (e.g., low current and low power) to be rotated. As such, for a given amount of power, the magnetic field transmitter assembly 300 can produce a rotating magnetic field that is stronger than a rotating magnetic field produced by coil-based magnetic field transmitter assemblies that do not have a rotating permanent magnet.

In some embodiments, a thin metal layer (e.g., aluminum foil) is positioned below the magnet 306 such that the rotating magnetic field induces a current in the metal layer. The induced current, in turn, generates a magnetic field itself that can repel the magnet 306 such that the magnet 306 levitates within the subassembly 304. In some embodiments, the metal layer is incorporated into or coupled to the enclosure 302. In some embodiments, the metal layer is 0.00001 inches to 0.01 inches thick. In some embodiments, the metal layer is 0.0005 inches to 0.005 inches thick. In some embodiments, the metal layer is substantially 0.0001 inches thick. In some embodiments, the metal layer comprises a non-magnetic and poorly conducting material, which may be thicker than the metal layer in proportion to the material's electrical resistivity. For example subassembly 304 may be constructed from a poor electrical conductor such as graphite to provide a levitation force comparable to aluminum foils. In some embodiments, the metal layer is circular shaped. In another embodiment, the metal forms a ring that is closer to the magnet than the above metal sheets.

In some embodiments, friction between the magnet 306 (and any coating) and the internal surfaces 326 is reduced by limiting contact area between the magnet 306 and the internal surfaces 326. The internal surfaces 326 may comprise features such as hemispherical bumps, one or more rings, a plurality of holes, or other features that reduce the contact area between the internal surfaces 326 and the magnet 306, thereby reducing friction between the magnet 306 and the internal surfaces 326. In some embodiments, the internal surfaces 326 comprise features analogous to an air foil that create upward lift on the magnet 306 during rotation. In other embodiments, air may be introduced into the space between the magnet 306 and the internal surfaces 326 having sufficient pressure to levitate the magnet 306 (e.g., an air bearing). In yet other embodiments, the magnet 306 is levitated by creating magnetic field gradients that help maintain the magnet's position at a center of the internal volume of the subassembly 304. The magnetic field gradients may utilize a separate set of gradient coils around the magnet 306 or may at least partially utilize magnetic fields generated by the first set of coils 308, the second set of coils 310, and the third set of coils 312. In some embodiments, the magnet 306 is levitated using electrostatic forces between like charges on the magnet 306 and the internal surfaces 326. In other embodiments a magnetic fluid (e.g., a ferrofluid) is inserted between the magnet 306 and the internal surfaces 326. The magnetic fluid would be magnetically attracted to the magnet 306 and rotate with the magnet 306, preventing the magnet 306 from contacting the internal surfaces 326.

The first magnetic field sensor 314, the second magnetic field sensor 316, and the third magnetic field sensor 318 can be coupled to the enclosure 302 and be configured to sense magnetic fields generated by the rotating magnet 306. The first magnetic field sensor 314, the second magnetic field sensor 316, and the third magnetic field sensor 318 can include inductive sensing coils and/or various sensing elements such as MR sensing elements (e.g., AMR sensing elements, GMR sensing elements, TMR sensing elements, Hall effect sensing elements, CMR sensing elements, EMR sensing elements, spin Hall sensing elements, and the like), GMI sensing elements, and/or flux-gate sensing elements. As will be discussed further below, the magnetic fields sensed by the first magnetic field sensor 314, the second magnetic field sensor 316, and the third magnetic field sensor 318 can be used to determine the amount of current applied to each of the coils of the magnetic field transmitter assembly 300.

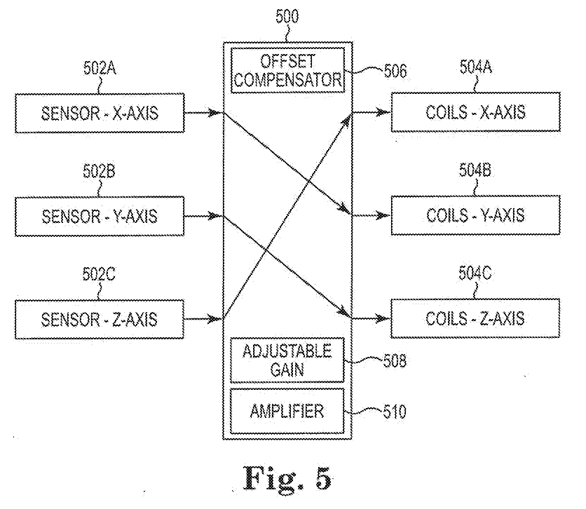

FIG. 5 shows a block representation of a magnetic field controller 500, a first magnetic field sensor 502A, a second magnetic field sensor 502B, and a third magnetic field sensor 502C, a first coil 504A, a second coil 504B, and a third coil 504C. The first magnetic field sensor 502A, the second magnetic field sensor 502B, the third magnetic field sensor 502C, the first coil 504A, the second coil 504B, and the third coil 504C can be part of a single magnetic field transmitter assembly. The magnetic field controller 500 is configured to control current to one or more magnetic field transmitter assemblies (e.g., magnetic field transmitter assemblies 106, 108, and 110 of FIG. 1 and 300 of FIGS. 3A and 3B). The magnetic field controller 500 can include various digital and/or analog components such as one or more offset compensators 506, one or more adjustable gain units 508, and one or more power amplifiers 510. The offset compensator 506 can comprise a potentiometer that is configured to be adjusted such that sensor output is zero when the sensor detects zero magnetic field strength. Alternatively, the sensor output can be digitized and the offset adjusted digitally. The adjustable gain units 508 are configured to amplify the sensor output. The amplified sensor output may control current delivered to the magnetic field transmitter assemblies. The adjustable gain units 508 may be implemented with a transconductance (voltage to current) amplifier that can supply AC current in the range of 70 to 700 milliamps rms. In certain embodiments, the magnetic field controller 500 includes an offset compensator, adjustable gain unit, and power amplifier for each axis (e.g., each set of coils) of each magnetic field transmitter assembly. The magnetic field controller 500 can be used as the magnetic field controller 118 in the tracking system 100 of FIG. 1.

For simplicity, FIG. 5 shows an example of how the magnetic field controller 500 is configured to control current to coils (i.e., the first coil 504A, the second coil 504B, and the third coil 504C) of only one magnetic field transmitter assembly. Similar approaches can be applied by the magnetic field controller 500 if the tracking system 100 includes multiple magnetic field transmitter assemblies. As described above, during operation, magnetic field transmitter assemblies are configured to generate an alternating magnetic field by moving (e.g., rotating) a magnet within each respective magnetic field transmitter assembly in a repetitive pattern. Each magnet is moved by applying and controlling currents applied to the coils surrounding the magnet. The applied current generates a magnetic field that causes the magnet to rotate.

The magnetic field controller 500 is configured to apply current to the first coil 504A wrapped around a first axis, the second coil 504B wrapped around a second axis, and the third coil 504C wrapped around a third axis. The first, second, and third axes can be orthogonal to each other such that the first coil 504A is considered to be a x-axis coil, the second coil 504B is considered to be a y-axis coil, and the third coil 504C is considered to be a z-axis coil. The first magnetic field sensor 502A is positioned with respect to the first coil 504A to sense magnetic fields in the x-axis direction, the second magnetic field sensor 502A is positioned with respect to the second coil 504B to sense magnetic fields in the y-axis direction, and the third magnetic field sensor 502C is positioned with respect to the third coil 504C to sense magnetic fields in the z-axis direction.

As indicated by arrows in FIG. 5, the magnetic fields (e.g., rotating magnetic fields) sensed by the x-axis magnetic field sensor (i.e., first sensor 502A) are used as input to the magnetic field controller 500 to determine an amount of current to be applied to the y-axis coil (i.e., second coil 504B). Similarly, the magnetic fields (e.g., rotating magnetic fields) sensed by the y-axis magnetic field sensor (i.e., second sensor 502B) are used as input to the magnetic field controller 500 to determine an amount of current to be applied to the z-axis coil (i.e., third coil 504C). And, the magnetic fields (e.g., rotating magnetic fields) sensed by the z-axis magnetic field sensor (i.e., third sensor 502C) are used as input to the magnetic field controller 500 to determine an amount of current to be applied to the x-axis coil (i.e., first coil 504A). In the above-described arrangement, the magnetic field controller 500 is configured to provide closed-loop control movement (e.g., rotation) of a magnet in a magnetic field transmitter assembly via the first magnetic field sensor 502A, the second magnetic field sensor 502B, and the third magnetic field sensor 502C.

In certain embodiments, the magnetic field controller 500 is configured to control current to the first coil 504A, the second coil 504B, and the third coil 504C such that the magnet moves at a substantially constant rate (e.g., revolutions per minute (RPMs)). In certain embodiments, a substantially constant rotation about any vector in space can be accomplished by providing a substantially constant torque to the magnet via the magnetic fields generated by the first coil 504A, the second coil 504B, and the third coil 504C. The Equations below describe relationships among torque, magnetic properties of the magnet, magnetic fields of the coils and magnet, current applied to the coils, and the magnetic fields sensed by the magnetic field sensors to achieve uniform rotation. Equation 1 shows an example expression for torque exerted on a permanent magnet by an applied magnetic field:

Vector Torque,T=MVH(m′×H′)=Tτ′ Equation 1

where M is magnetic magnetization (in Tesla) of the magnet, V is volume of the magnet in meters cubed, H is the magnitude of the coil magnetic field in amps per meter, m′ is a unit vector directed along the magnetization of the magnet, H′ is a unit vector directed along the magnetic field of the coils, T is the magnitude of the torque (MVH), and τ′ is a unit vector directed along the toque vector (m′×H′). The symbol X is the vector cross product.

Equation 2 shows the rotating magnet unit vector m′ in terms of its polar and aziumuth angles θ and φ:

m′=sin(θ)*cos(φ)I′+sin(θ)*sin(φ)J′+cos(θ)K′ Equation 2

where θ is the polar angle unit of the vector m′ of the magnetization of the magnet, φ is the azimuth angle of the unit vector m′, and I′, J′, and K′ represent the x-, y-, and z-axis components.

From Equation 1, the magnet will experience uniform torque about the torque unit vector τ′ if the magnetic field is constructed to be perpendicular to both the torque and the magnet magnetization (e.g., H′=τ′×m′). Inserting this expression into Equation 1 and manipulating the cross product shows that the torque has uniform magnitude T=MVH directed along the torque unit vector τ′. When the magnet experiences uniform torque, it will accelerate until the applied torque MVH is equal to the dissipative torques provided by friction, air resistance, induced currents in metals, or back emf currents.

For example, when the magnet rotates around the z-axis (as will be described in more detail below) τ′=K′ and θ is π/2 in Equation 2, so H′=K′×m′ is becomes:

H=−sin(φ)+cos(φ)J Equation 3

where φ=ωt, and the angular rate ω=2πf, where f is the rotation frequency in Hz, and t is the time in seconds. That is, the magnetic field for uniform rotation around the z axis has an x component proportional to minus the y component of the magnet magnetization vector, and a y component proportional to the x component of the magnetization vector.

The first magnetic field sensor 502A, the second magnetic field sensor 502B, and the third magnetic field sensor 502C sense x, y, and z components of the rotating magnetic field generated by the rotating magnet, represented as a magnetic dipole, as follows:

Sensor (x-axis) Sₓ=((M*V)/(2*π*R³))*sin(θ)*cos(φ) Equation 4

Sensor (y-axis) S_{y}=((M*V)/(2*π*R³))*sin(θ)*sin(φ) Equation 5

Sensor (z-axis) S_{z}=((M*V)/(2*π*R³))*cos(θ) Equation 6

where R is the radius of the magnet. In vector format, S=((M*V)/(2*π*R3))m′.

When the magnet rotates around the z-axis and θ is π/2, expressions for the first magnetic field sensor 502A, the second magnetic field sensor 502B, and the third magnetic field sensor 502C are as follows:

Sensor (x-axis) Sₓ=((M*V)/(2*π*R³))*cos(φ) Equation 7

Sensor (y-axis) S_{y}=((M*V)/(2*π*R³))*sin(φ) Equation 8

Sensor (z-axis) S_{z}=0 Equation 9

Comparing Equation 3 with Equations 7-9, it can be seen that the x-axis component of H—the magnetic field generated by the coils—is proportional to −S_{y}. And, it can be seen that that the y-axis component of H is proportional to Sₓ.

The magnetic field between the coils of a square Helmholtz coil of FIG. 3B can be expressed as:

Hα(N*I)/s Equation 10

where N is the number of turns of wire carrying current, I, and s is the length of a side of the coils in meters. Because N and s are constants, it can be seen that the current, I, is proportional to the sensor sensing signals when the magnet rotates around the z-axis and θ is π/2.

Iₓα−S_{y} Equation 11

I_{y}αSₓ Equation 12

Applying the approach outlined in Equations 1-12 above, Table 1 summarizes relationships between sensor sensing signals and coil current for uniform rotation about the x, y, and z axes and for rotation about an arbitrary torque vector. The bottom row of Table 1 summaries relationships between coil current and an arbitrary rotational axis.

TABLE 1

| | X coil current | Y coil current | Z coil current |
|---|---|---|---|
| Rotation Axis | proportional to | proportional to | proportional to |
| x | 0 | −S_{z} | S_{y} |
| y | S_{z} | 0 | −Sₓ |
| z | −S_{y} | Sₓ | 0 |
| Rotation about | T_{y}S_{z}-T_{z}S_{y} | T_{z}Sₓ-TₓS_{z} | TₓS_{y}-T_{y}Sₓ |
| arbitrary axis T | | | |

The above-summarized relationships show how the sensor outputs Sₓ, S_{y}, and S_{z} can drive the X, Y, and Z coils to generate uniform rotation about the indicated axes.

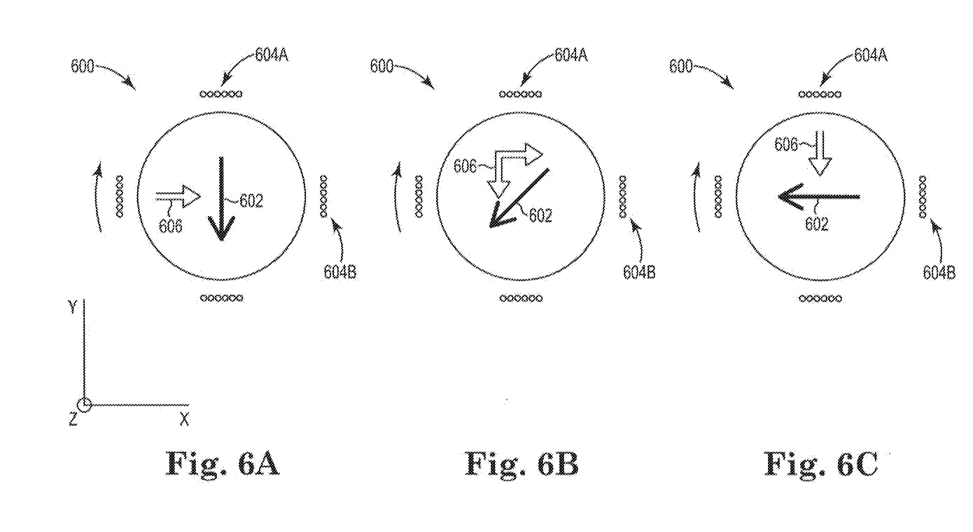

FIGS. 6A-C show schematic representations of a magnet 600 at various points of rotation while rotating around a z-axis within one of the above-described magnetic field transmitter assemblies. The magnet 600 has a preferred magnetic orientation, which is represented by an arrow 602. As described above, to rotate the magnet 600, a current is applied to coils surrounding the magnet 600. FIGS. 6A-C show a first set of coils 604A and a second set of coils 604B. The first set of coils 604A are wrapped around the x-axis, and the second set of coils 604B are wrapped around the y-axis.

To rotate the magnet 600 around the z-axis, when the magnet's preferred magnetic orientation 602 is aligned with the y-axis (see FIG. 6A), the first set of coils 604A should be energized to generate a magnetic field along the x-axis represented by arrow 606. The current through the first set of coils 604A should be larger or be the only current compared to current through the second set of coils 604B. A generated magnetic field along the x-axis causes the magnet 600 to rotate because the magnet 600 rotates to align its preferred magnetic orientation 602 along the direction of the magnetic field long the x-axis.

While the magnet 600 rotates such that the magnet's preferred orientation 602 is aligned between the x-axis and the y-axis (see FIG. 6B), both the first set of coils 604A and the second set of coils 604B can be energized to generate magnetic fields along the x-axis and y-axis represented by arrow 606. The magnetic field along the x-axis continues to attract the magnet 600 such that the magnet's preferred magnetic orientation 602 aligns with the direction of the magnetic field along the x-axis. Similarly, the magnetic field along the y-axis can repel the magnet 600 such that the magnet's preferred magnetic orientation 602 rotates towards the x-axis.

Once the magnet 600 rotates to align its preferred magnetic orientation 602 with the x-axis (see FIG. 6C), the second set of coils 604B can be energized to generate a magnetic field along the y-axis represented by arrow 606. The current through the second set of coils 604B should be larger or be the only current compared to current through the first set of coils 604A. A generated magnetic field along the y-axis causes the magnet 600 to rotate because the magnet 600 rotates to align its preferred magnetic orientation 602 along the direction of the magnetic field long the y-axis.

The first and second sets of coils 604A-B can continue to be energized and de-energized to rotate the magnet 600 within a magnetic field transmitter assembly such that the magnet 600 (and therefore magnetic field transmitter assembly) generates a rotating magnetic field. In certain embodiments, rotation of the magnet 600 begins to occur automatically when power is applied to the sensors connected to coils. The generated magnetic fields accelerate and rotate the magnet 600 regardless of the magnet's starting position/orientation.

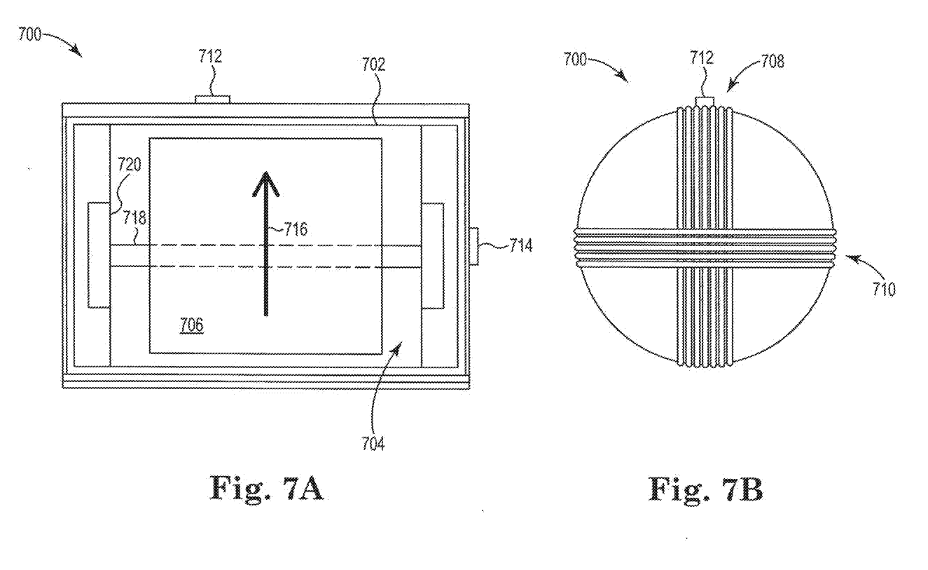

FIGS. 7A and 7B show schematics of a magnetic field transmitter assembly 700 including an enclosure 702, a subassembly 704, a magnet 706, a first set of coils 708, a second set of coils 710, a first magnetic field sensor 712, and a second magnetic field sensor 714. Each set of coils can be comprised of a single wire with multiple coil turns around the enclosure 702. The coils can be comprised of conductive materials such as copper.

The first set of coils 708 and the second set of coils 710 are wrapped around the enclosure 702, which houses the subassembly 704 and the magnet 706. Although the enclosure 702 is shown as being sphere shaped in FIGS. 7A and 7B, the enclosure 702 can be other shapes (e.g., cube, cuboid, ellipsoid, cylindrical). For simplicity, only a few coil turns are shown as being included in the first set of coils 708 and the second set of coils 710, but each set of coils can include many coils turns. In some embodiments, the sets of coils are wrapped such that the coils substantially cover the enclosure 702. In some embodiments, the sets of coils are wrapped orthogonally with respect to each other. In some embodiments, each set of coils is wrapped in a Helmholtz coil arrangement, which can be referred to as a 3-axis Helmholtz arrangement.

The magnet 706 can comprise various magnetic materials such as Nd, Fe, Co, Sm, and the like. For example, the magnet 706 can comprise permanent magnetic materials such as NdFeB, SmCo, and the like. In some embodiments, the magnet 706 includes a coating that is coated around the permanent magnetic materials and that has a low coefficient of friction and/or high resistance to wear (e.g., to prevent corrosion). For example, the coating can include metal plating (e.g., Ni) surrounding the permanent magnetic materials. In other examples, the coating includes fluoropolymers (including ceramic reinforced fluoropolymers), waxes, oils/hydrocarbons, silicones, paylene, water, plasma coatings, graphite, acetal, PEEK, HDPE, ceramics, oxides/nitrides and the like. The magnet 706 can be a dipole, have a preferred magnetic orientation (represented by arrow 716 in FIG. 7A), and have a uniform magnetization throughout the permanent magnetic material within the magnet 706. In some embodiments, the magnet 706 is cylinder shaped and has a diameter of 0.25″ to 2″. In some embodiments, the magnet 706 has a diameter of 0.25″ to 1″.

The magnet 706 can be positioned in the subassembly 704, which is shown including a shaft 718 and bearings 720. The shaft 718 is shown as extending through the magnet 706, for example, through a central hole. The subassembly 704 and the enclosure 702 can comprise non-magnetic materials. In certain embodiments, the bearings 720 comprise non-magnetic materials and are constructed to rotate the magnet 706 at high speeds. In some embodiments, the magnet 706 is attached to a single bearing placed around a center of the magnet 706. Using a single bearing eliminates issues of alignment of the multiple bearings. A lubricant (e.g., oils, greases, waxes, silicone, graphite, fluoropolymers) can be applied to the bearings 720 to reduce friction.

During operation, the magnetic field transmitter assembly 700 is configured to generate a rotating magnetic field. The rotating magnetic field is generated by rotating the magnet 706. In some embodiments, the magnet 706 is rotated at 5000 RPMs to 200,000 RPMs. In some embodiments, the magnet 706 is rotated at 40,000 RPMs to 70,000 RPMs. In some embodiments, the magnet 706 is rotated at 48,000 RPMs to 60,000 RPMs. The magnet 706 is rotated by applying and controlling current applied to the coils (i.e., the first set of coils 708 and the second set of coils 710) surrounding the enclosure 702. The applied current generates a magnetic field that, when controlled, causes the magnet 706 to rotate via a controlled torque.

The first magnetic field sensor 712 and the second magnetic field sensor 714 can be coupled to the enclosure 702 and be configured to sense magnetic fields generated by the rotating magnet. The first magnetic field sensor 712 and the second magnetic field sensor 714 can include inductive sensing coils and/or various sensing elements such as MR sensing elements (e.g., AMR sensing elements, GMR sensing elements, TMR sensing elements, Hall effect sensing elements, CMR sensing elements, EMR sensing elements, spin Hall sensing elements, and the like), GMI sensing elements, and/or flux-gate sensing elements.

Like the above-described embodiments, a magnetic field controller can be configured to provide closed-loop control rotation of the magnet 706 in the magnetic field transmitter assembly 700 via the first magnetic field sensor 712 and the second magnetic field sensor 714.

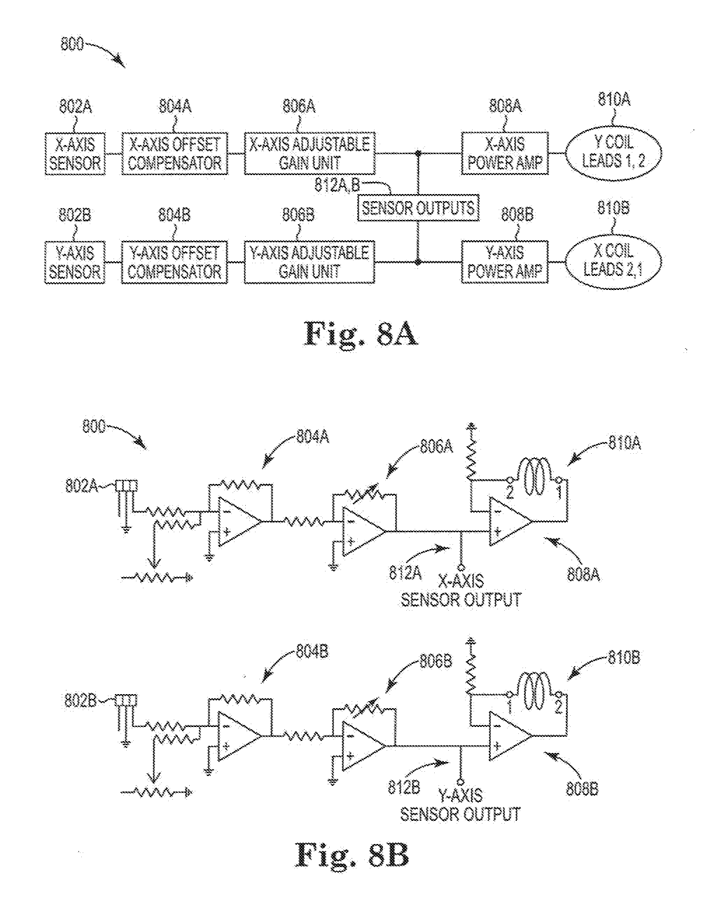

FIG. 8A shows a schematic of components of magnetic field controller circuitry 800 for rotating the magnet 700 of FIG. 7 about the magnet's central axis (e.g., longitudinal axis). FIG. 8B shows particular examples of components for the circuitry 800. The circuitry 800 includes an x-axis magnetic sensor 802A and a y-axis magnetic sensor 802B (e.g., Hall-effect sensors), an x-axis offset compensator 804A and a y-axis offset compensator 8048 (e.g., shown as operational amplifiers in FIG. 8B), an x-axis adjustable gain unit 806A and a y-axis adjustable gain unit 806B (e.g., shown as operational amplifiers in FIG. 8B), and an x-axis power amplifier 808A and a y-axis power amplifier 8088 (e.g., shown as transconductance (voltage to current) power amplifiers in FIG. 88B). The x-axis power amplifier 808A and the y-axis power amplifier 8088 are electrically coupled to respective x-axis coil leads 810A and y-axis coil leads 810B. The x-axis magnetic sensor 802A and the y-axis magnetic sensor 802B have respective sensor outputs 812A, 812B. The sensor outputs 812A, 812B are configured to track the angular position of the magnet 700 and are correlated with the magnetic fields sensed by the receivers 102 (e.g., magnetic sensors) in the medical device 104 being tracked.

In the embodiments of FIGS. 7A-B and 8A-B where the magnet 700 is rotating along a central axis (which could be considered the z-axis), the first set of coils 708 (i.e., the x-axis coils) and the second set of coils 710 (i.e., the y-axis coils) provide a substantially constant torque on the magnet 700 as it rotates by using the prescription in Table 1 for rotation about the z-axis. The rotation speed of the magnet 700 is proportional to the gain of the x-axis adjustable gain unit 806A and the y-axis adjustable gain unit 806B.

In some embodiments, the magnet's rotation frequency is controlled so that the rotating magnetic field occurs at a precise rate. Frequency control may be achieved when the x-axis adjustable gain unit 806A and the y-axis adjustable gain unit 806B are voltage controlled gain amplifiers. In such embodiments, the sensor signal outputs 812A, 812B are first sent to a tachometer, which provides a voltage proportional to frequency. The measured voltage is compared to a user set voltage, and the difference is fed to the voltage controlled gain amplifiers. Using such an approach, it is possible to control frequency at a sub-Hertz order.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A system comprising:
a magnetic field transmitter assembly including:
an enclosure,
a magnet positioned within the enclosure, and
a plurality of coils wrapped around the enclosure and including a first set of windings and a second set of windings, wherein the first set of windings is configured to generate a first magnetic field in a first direction, wherein the second set of windings is configured to generate a second magnetic field in a second direction different than the first direction, and wherein the plurality of coils are configured to be driven to rotate the magnet.

2. The system of claim 1, wherein the magnet comprises either NeFeB or SmCo.

3. The system of claim 1, wherein the magnet includes a coating.

4. The system of claim 1 wherein the magnet has a single preferred magnetic orientation.

5. The system of claim 1, wherein the magnet is either a sphere or a cylinder.

6. The system of claim 1, wherein the magnet has a diameter of 0.1 inch-1 inch.

7. The system of claim 1 wherein the magnet is a dipole magnet.

8. The system of claim 1, wherein the magnetic field transmitter assembly includes a subassembly positioned within the enclosure and that forms an internal volume in which the magnet is positioned.

9. The system of claim 8, wherein the subassembly includes a clam-shell assembly that forms the internal volume.

10. The system of claim 8, wherein the internal volume includes a lubricant.

11. The system of claim 8, wherein the subassembly comprises a non-magnetic material.

12. The system of claim 1, wherein the plurality of coils further includes a third set of windings wrapped orthogonally to the first set of windings and the second set of windings.

13. The system of claim 1, wherein the plurality of coils includes either two or three sets of Helmholtz-paired windings.

14. The system of claim 1, further comprising:
circuitry configured to control current to the plurality of coils to produce a substantially constant torque to the magnet.

15. The system of claim 14, wherein the circuitry includes an offset compensator, an adjustable gain unit, and a power amplifier.

16. A method for using a magnetic field transmitter assembly to generate a rotating magnetic field, the magnetic field transmitter assembly including an enclosure, a magnet positioned within the enclosure, and a plurality of coils positioned around the enclosure, the method comprising:
energizing the plurality of coils to generate a plurality of magnetic fields that move the magnet such that the magnetic field transmitter assembly generates a rotating magnetic field.

17. The method of claim 16, wherein the magnet is moved to rotate around a single axis.

18. The method of claim 16, wherein the magnet is moved to rotate such that a magnetization vector of the magnet traverses all directions.

19. The method of claim 16, further comprising:
tracking a position and orientation of a medical device by sensing phase and/or amplitude of the rotating magnetic field with a magnetic sensor positioned in the medical device.

20. The method of claim 16, wherein the magnet is rotated at 5000 revolutions per minute (RPMs) to 200,000 RPMs.
